(19) United States
(12) Patent Application Publication
(10) Pub. No.: US 2014/0351178 A1
(43) Pub. Date: Nov. 27, 2014

(54) ITERATIVE WORD LIST EXPANSION

(71) Applicants: Daria Bogdanova, Moscow (RU); Nikolay Kopylov, Moscow (RU)

(72) Inventors: Daria Bogdanova, Moscow (RU); Nikolay Kopylov, Moscow (RU)

(73) Assignee: ABBYY InfoPoisk LLC, Moscow (RU)

(21) Appl. No.: 14/283,767

(22) Filed: May 21, 2014

(30) Foreign Application Priority Data
May 24, 2013 (RU) 2013123795

(51) Int. Cl. G06N 5/04; G06N 99/00

(52) U.S. Cl. CPC G06N 5/04; G06N 99/005
USPC 706/12

(57) ABSTRACT

Methods and systems are provided for expanding an electronic word list, containing a set of words where each word is associated with a label from a first set of labels. A subset of training data containing a set of texts having a second set of labels is obtained. For each word in the electronic word list and a label in the sub-set of the training data, a feature selection criterion is calculated. One or more words are selected, for which resulting value of the feature selection criterion calculation is greater than a predetermined threshold value. The one or more selected words are added to the electronic word list.

### CROSS-REFERENCE TO RELATED APPLICATIONS

This application claims priority under 35 USC 119 to Russian patent application No. 2013123795, filed on May 24, 2013, the disclosure of which is incorporated herein by reference.

### BACKGROUND

The present disclosure generally relates to methods and systems for processing of electronic word lists. In some tasks of natural language processing, text analysis is performed with the help of word lists or other word compilations. The electronic word lists may be static and created manually. However, manual creation of large lists of terms, and then manually expanding them is both time-consuming and expensive. As a result of language usage changes, existing word lists may need to be updated with new words.

### SUMMARY

An exemplary embodiment relates to a method for expansion of an electronic word list. The method includes obtaining the electronic word list containing a set of words, wherein each word is associated with a label from a first set of labels. The method further includes obtaining a subset of training data containing a set of texts having a second set of labels. The method further includes for each word in the electronic word list and a label in the sub-set of the training data, calculating a feature selection criterion. The method further includes selecting one or more words for which resulting value of the feature selection criterion calculation is greater than a predetermined threshold value. The method further includes adding the one or more selected words to the electronic word list.

Another exemplary embodiment relates to a system comprising: one or more data processors; and one or more storage devices storing instructions that, when executed by the one or more data processors, cause the one or more data processors to perform operations. The operations comprise obtaining the electronic word list containing a set of words, wherein each word is associated with a label from a first set of labels. The operations further comprise obtaining a subset of training data containing a set of texts having a second set of labels. The operations further comprise for each word in the electronic word list and a label in the sub-set of the training data, calculating a feature selection criterion. The operations further comprise selecting one or more words for which resulting value of the feature selection criterion calculation is greater than a predetermined threshold value. The operations further comprise adding the one or more selected words to the electronic word list.

Yet another exemplary embodiment relates to computer readable storage medium having machine instructions stored therein, the instructions being executable by a processor to cause the processor to perform operations. The operations comprise obtaining the electronic word list containing a set of words, wherein each word is associated with a label from a first set of labels. The operations further comprise obtaining a subset of training data containing a set of texts having a second set of labels. The operations further comprise for each word in the electronic word list and a label in the sub-set of the training data, calculating a feature selection criterion. The operations further comprise selecting one or more words for which resulting value of the feature selection criterion calculation is greater than a predetermined threshold value. The operations further comprise adding the one or more selected words to the electronic word list.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1A is an illustration of an electronic word list of geographical lexical variation for the Russian language, in accordance with one embodiment;

FIG. 1B is an illustration of an English translation of the text in FIG. 1A, in accordance with one embodiment;

FIG. 1C is an illustration of an electronic word list of sentiment lexicon where sentiments are nominal values, in accordance with one embodiment;

FIG. 1D is an illustration of an electronic word list of sentiment lexicon where sentiments are real values, in accordance with one embodiment;

FIG. 2 shows a flow diagram of a process for electronic word list expansion, in accordance with one embodiment;

FIG. 3 shows a flow diagram of a process for feature selection criteria combination, in accordance with one embodiment;

FIG. 4 is a flow diagram of a process for electronic word list expansion using training data, in accordance with one embodiment;

FIG. 5 is a flow diagram of a process for electronic word list expansion where terms in the electronic word list are weighted, in accordance with one embodiment;

FIG. 6 is a flow diagram of a process for selection of training subset, in accordance with one embodiment;

FIG. 7A is a flow diagram of a process for performing electronic word list expansion and text analysis, in accordance with one embodiment;

FIG. 7B is a flow diagram of a process for text analysis using expanded word list, in accordance with one embodiment;

FIG. 8A is a flow diagram of a process for parameter tuning, in accordance with one embodiment;

FIG. 8B is a flow diagram of a process for accuracy estimation in parameter tuning, in accordance with one embodiment; and

FIG. 9 shows a hardware block diagram for a system, in accordance with one embodiment.

### DETAILED DESCRIPTION

In the following description, for purposes of explanation, numerous specific details are set forth in order to provide a thorough understanding of the techniques described herein. It will be apparent, however, to one skilled in the art that the techniques can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment, nor are separate or alternative-embodiments mutually exclusive of other embodiments. Moreover, various features are described which may be exhibited by some embodiments and not by others. Similarly, various requirements are described which may be requirements for some embodiments but not other embodiments.

Some natural language processing tasks involve usage of word lists, where each word in the word list may be associated with a category, area, or a number. As used herein, a set of words, where each word is associated with a certain category, may be called a word list or an electronic word list (may also be called, glossary, vocabulary, etc.). Embodiments disclose a computer-implemented method and a system for iterative word list expansion and document classification based on the expanded word list.

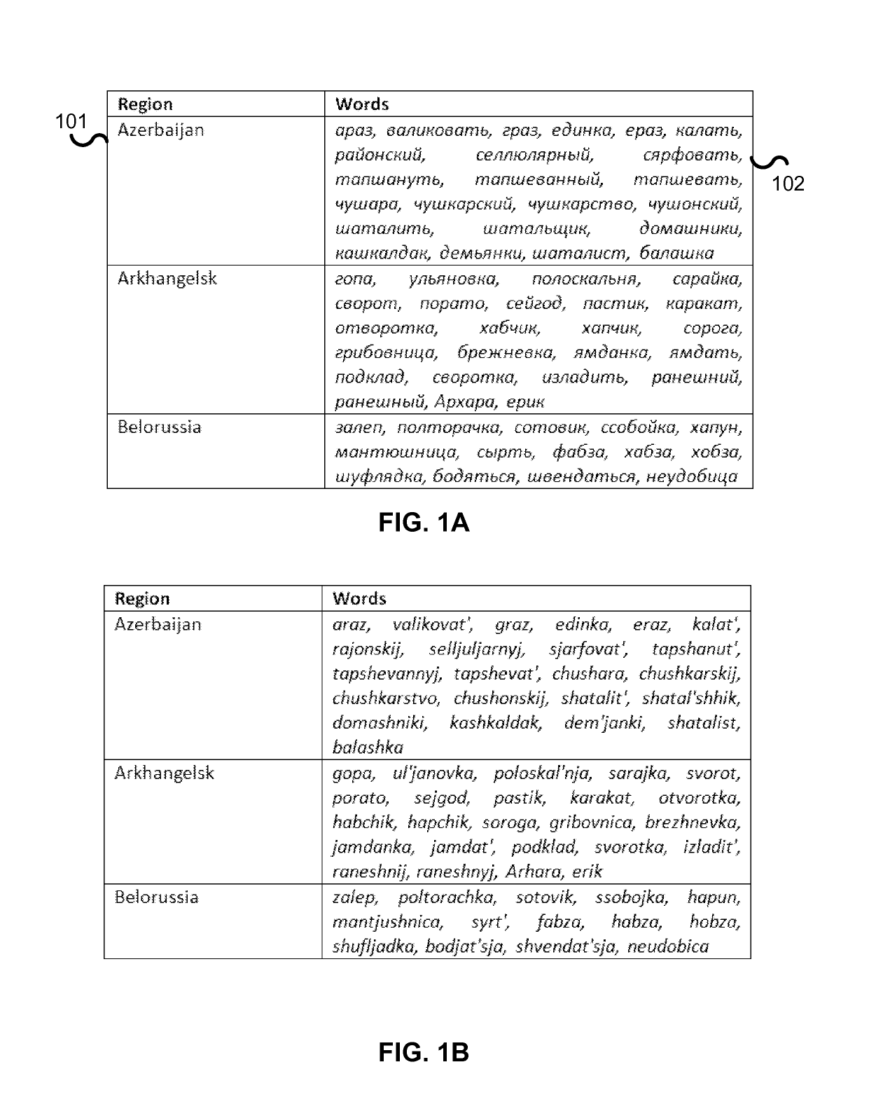

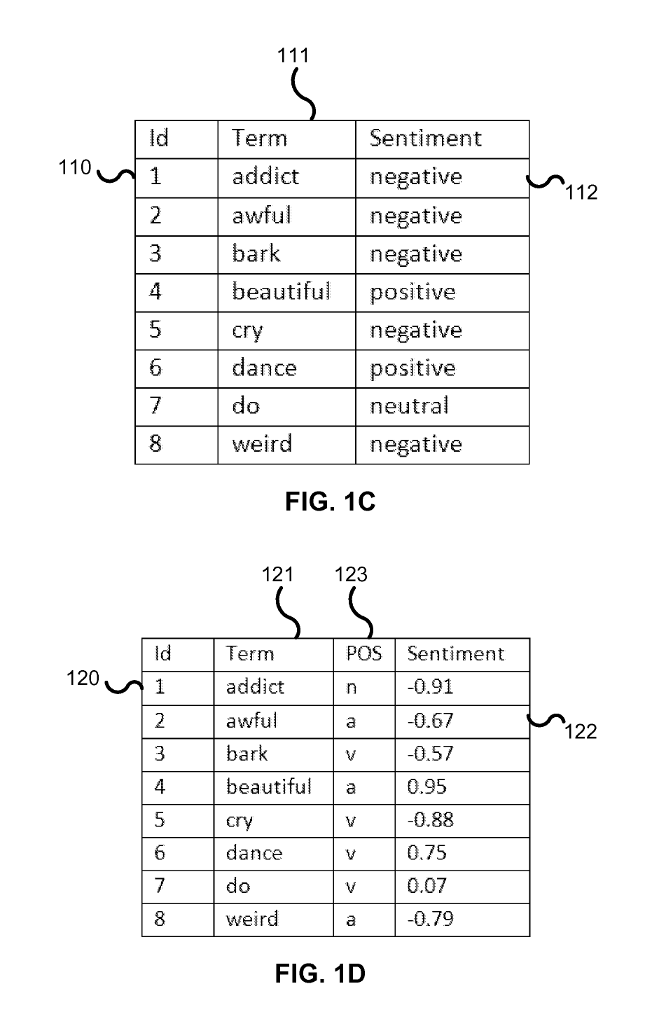

The word list may be presented as a number of labeled lists of words or terms. For example, the word list of regional variations of the language may include words, that are specific to each geographic region, i.e., each word in such word list may be related to a geographical zone which in this case is the label. All possible labels comprise a label set (or a set of tags). FIG. 1A illustrates an example of a portion of the regional variation word list of the Russian language. The word list represents several lists of words 102, each of which is associated with a category 101 from the set of labels of geographical regions where the Russian language is spoken.

FIG. 1C illustrates an example of a portion of a word list having word tonality. Each word 111 is labeled with a sentiment or tonality label 112. In this example, a label set may include all possible values of a sentiment or tonality label. Other information may be provided for each term or word 111 including, but not limited to, an identifier 110, or grammatical characteristics (e.g., a part of speech (POS) or tag).

FIG. 1D illustrates an example of a portion of a word list having word tonality, where the word tonality is represented with numeric values. Each term or word 121 has a sentiment or tonality label 122, where the negative values correspond to negative sentiments or tone and positive values correspond to positive tone. The absolute value of the tonality label 122 may convey the strength of the sentiment or tone of the word. In this case, a label set is an interval which represents the domain of the sentiment label, i.e., all possible values of the sentiment or tonality label. An identifier (“Id”) 120 and other information (e.g., a part of speech tag 123) may be specified for each word 121.

The word list can be represented as a set of smaller word lists 101 associated with labels 102. The word list may also be represented as a list of words 111, 121 where each word has a label 112, 122. The labels may be either text 112 or numeric 122. Words may have other labels or tags, such as an identifier 110, 120 or a part of speech tag 123.

Such word lists may be used for text classification, and the labels may match with the names of classes of documents. In the case of classification of regional language variations, where words in the word list are labeled with the names of geographical regions, the classes in the classification task may partially or completely match with the labels of the word list, or a mapping may be establish between them. For example, the labels in the word list may represent names of populated geographical areas (even small cities may be mentioned as regions), while the classes in the classification task may contain areas, regions, Republics, provinces, or territories (i.e., aggregations of smaller regions into bigger areas, which may result in fewer number of classes than the number of word list labels).

In case of classification by author gender , where classes are “male” and “female” and in some cases as well “unknown”, the labels of the word list words may be different from the class labels. For example, word list words may include the following labels: “positive lexicon”, “negative lexicon”, “joy”, “sadness” and other categories, the presence of which in the text may indicate the gender of the author. That is the frequency of these terms in the texts authored by a female author significantly differs from the frequency of these terms in texts authored by male authors.

A method and a system are disclosed for iterative expansion of an electronic word list using a plurality of training texts. The method may include steps of: performing at least once the following: form training subset of documents, selecting words from the training subset, adding these words to the electronic word list in accordance with corresponding labels.

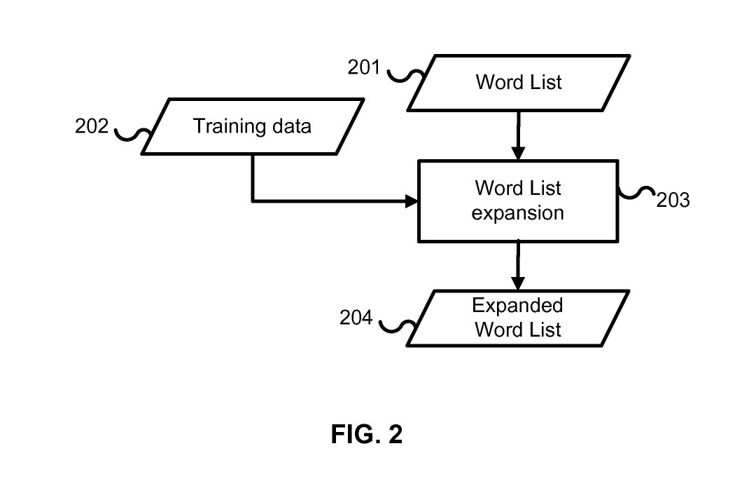

FIG. 2 illustrates a flow diagram of a process of word list expansion according to one or more embodiments. The process can be implemented on a computing device (e.g., a user device). In one embodiment, the process is encoded on a computer-readable medium that contains instructions that, when executed by the computing device, cause the computing device to perform operations of the process.

A word list 201 may be iteratively expanded (203) using training set of documents 202. As a result, an expanded word list 204 is obtained.

In some embodiments, the training set of documents 202 is needed. The training set may be represented as a set of texts having category labels or numeric values. The set of labels associated with the training set (i.e., all possible categories of the training set) may match (or include) the set of labels of the word list (i.e., various possible labels of the word list). The categories of the training set may differ from the categories of the word list, in which case a mapping between these categories may be needed. For example, the word list may have no labels, with the words having identifiers, while the training set may be marked by topics, in which case mapping between the word identifiers and topics may be provided. In another example, the labels of the word list may be countries, while the labels of the training set may be cities. In this example, a mapping between the cities and the countries may be needed.

If the labels of the word list are provided as numeric values (e.g., real numbers between −1 and 1) and the labels of the training set are provided as real numbers between 0 and 10, then a mapping between intervals [0;10] to [−1;1] is needed. For example,

$$dictVal = \frac{trainVal}{5} - 1 ,$$

where dictVal is a label value in the word list and trainVal is a label value in the training set.

In one embodiment, a feature selection process may be employed. Feature selection is the process of determining the most useful features (or characteristics) for a solution of a particular task. The usefulness of the feature is usually measured with feature selection criteria. These criteria can include chi-square statistic feature selection criterion which estimates the dependence between a class and a feature.

In statistics, the chi-square test is used to determine the independence of two events, i.e., events A and B are independent if P(AB)=P(A)·P(B), i.e., P(A|B)=P(A) and P(B|A)=P(B). To estimate the usefulness of a feature in the task of classification, the independence of the feature occurrence and the class occurrence may be tested. For example, for a class C and a word (feature) w, all the documents of the training set may be divided into four following groups: X_{w} documents of class C in which w occurs; Y_{w} documents that are not of class C in which w occurs; X documents of class C in which w does not occur; Y documents that are not of class C in which w does not occur. Therefore, total number of the documents is N=X_{w}+Y_{w}+X+Y.

| | | |
|---|---|---|
| | 1. C | 2. No C |
| 3. w | X_{w} | Y_{w} |
| No w | X | Y |

Then the value of chi-square statistics for feature selection may be calculated as follows:

$${χ}^{2} ( w , C ) = \frac{{N ( {X}_{w} \cdot Y - {Y}_{w} \cdot X )}^{2}}{( {X}_{w} + X ) ( {X}_{w} + {Y}_{w} ) ( X + Y ) ( X + {Y}_{w} )}$$

As a result, the more documents of class C include w and the more documents that are not of class C that do not contain w, the higher the chi-square value of the criteria of feature selection. On the other hand, the more documents of class C without w and the more documents that are not of class C with w, the lower the chi-square value.

In one embodiment, a method may be utilized that combines feature selection criteria. A number of feature selection criteria may be considered, and then a subset of two or more criteria may be extracted. This may be done for example by estimating the correlation of different criteria and selecting the least correlated criteria, because low correlation may indicate that the criteria evaluates various aspects of the importance of characteristics. Then, for each word, the selected criteria are calculated, the obtained values are normalized, and the maximum value of the normalized criteria is selected.

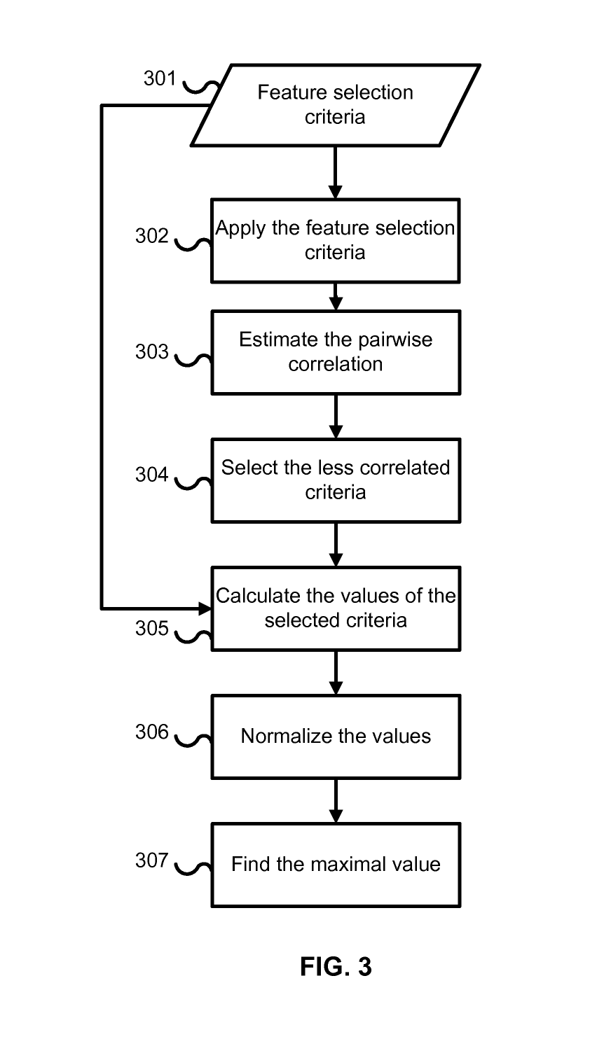

FIG. 3 shows a flow diagram of a process for combining the criteria of feature selection. A number of feature selection criteria 301 may be considered. First, all the feature selection criteria are applied to some data and a number of values are obtained for all criteria 302. Second, the pairwise correlation between the criteria, is estimated 303, i.e., for each pair of the criteria X and Y presented with their values X₁, . . . Xₙ and Y₁, . . . Yₙ respectively, a correlation is estimated, for example, with a Pearson correlation coefficient, which is calculated as follows:

$$r = \frac{{\sum }_{i = 1}^{n} ( {X}_{i} - \overline{X} ) ( {Y}_{i} - \overline{Y} )}{\sqrt{{\sum }_{i = 1}^{n} ( {X}_{i} - \overline{X} )} \sqrt{{\sum }_{i = 1}^{n} ( {Y}_{i} - \overline{Y} )}}$$

where X is an average value of Xᵢ, i.e.,

$$\overline{X} = \frac{{\sum }_{i = 1}^{n} {X}_{i}}{n}$$

At 304, the least correlated criteria are selected. The least correlated criteria may be pairs of criteria with the smallest correlation values, or the pairs of criteria with low correlation (e.g., with correlation that is less than a predetermined or predefined threshold).

Then, the values of the selected criteria are calculated 305 using the training data 202. The values are normalized 306, so that all the criteria values are within the same range (e.g., [0;1]). The maximum value of all the normalized values is then selected 307. This value is then considered as the value of the combination of feature selection criteria.

In some embodiments, the correlation estimation steps 302-304 of the criteria combination method may be omitted. In these embodiments, with the set of feature selection criteria 301, value of each criterion is calculated 305, normalized 306, and the maximum value is selected 307.

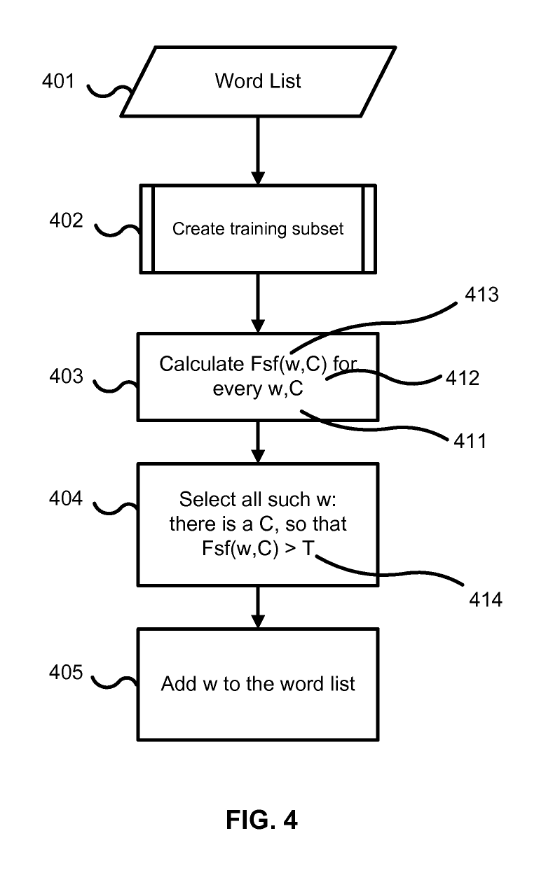

FIG. 4 shows a flow diagram of a process for expansion of the word list 203. First, to expand a word list 401, a subset of the set of training data 202 is created 402. Then, for each w 411, and C 412, where w 411 is a word representing a term in the word list 401, and C 412 is a class label of the training set 202, a features selection function Fsf 412 is calculated 403. A feature selection function Fsf 412 may be calculated as a value of one features selection criterion or as a value of a combination of a number of feature selection criteria (an example is shown in FIG. 3). Then, the terms w are selected, for which the Fsf value is more than a threshold value T 414, and are added 405 to the word list 401.

In some embodiments, weights are assigned to terms in the word list. The weights may represent the extent of reliability of the labels' (or tags) presence of a particular word, or a probability that a given word in a certain context may be marked with a given label. As a result, terms or words added manually to a word list (i.e., words which are more reliable) may be distinguished from those words that are added automatically or programmatically by a computer or computer program or service (e.g., such words may be less reliable).

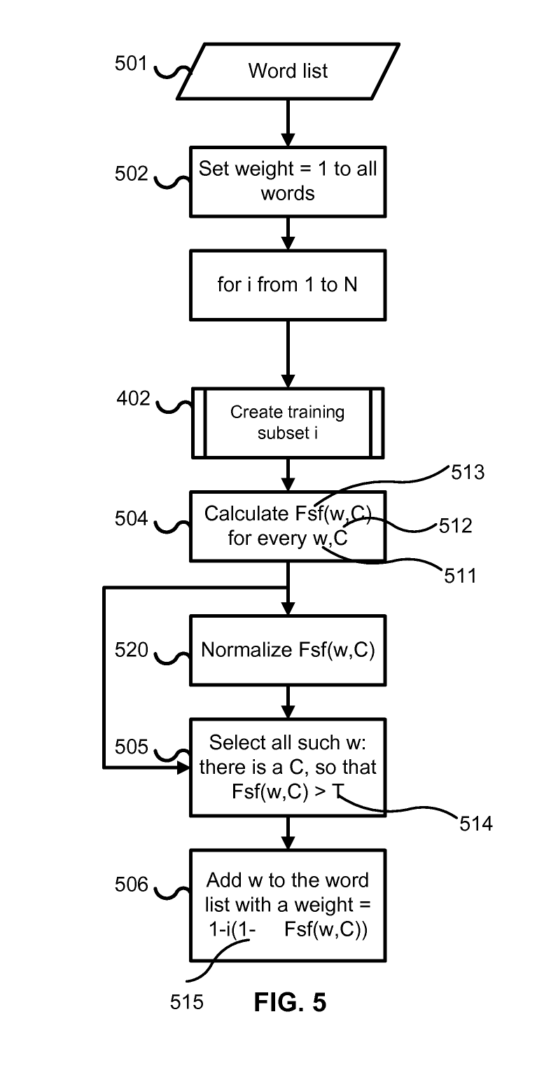

FIG. 5 shows a flow diagram of a process in which words in a word list are assigned weights. All the words initially present in a word list 501 (which may have been added manually) are assigned a maximum weight 502. In this example, the maximum possible weight is 1. Then, the following steps are repeated iteratively. A subset of the training set of documents containing words from the word list is formulated 402. For all the words w 511 in the training subset and all the labels of class C 512, a feature selection function Fsf(w,C) 513 is calculated (504) as a value of a feature selection criterion or a combination of feature selection criteria (an example is shown in FIG. 3). The values of the criterion (or the values of the combination of criteria) are optionally normalized (520) so that the values are in the range between 0 and 1 or other specified numeric values. The words are selected (505) for which the value of the criterion (or combination of criteria) is more than a threshold T 514 or a given number/proportion of all words with the highest values (i.e., given percent of all the terms). Each of the selected words are added (506) to the word list with the weight 515 directly proportional to the value of Fsf(w,C) 513 and inversely proportional to the number of iteration (the higher the iteration number, the less reliable are the labels of the added terms).

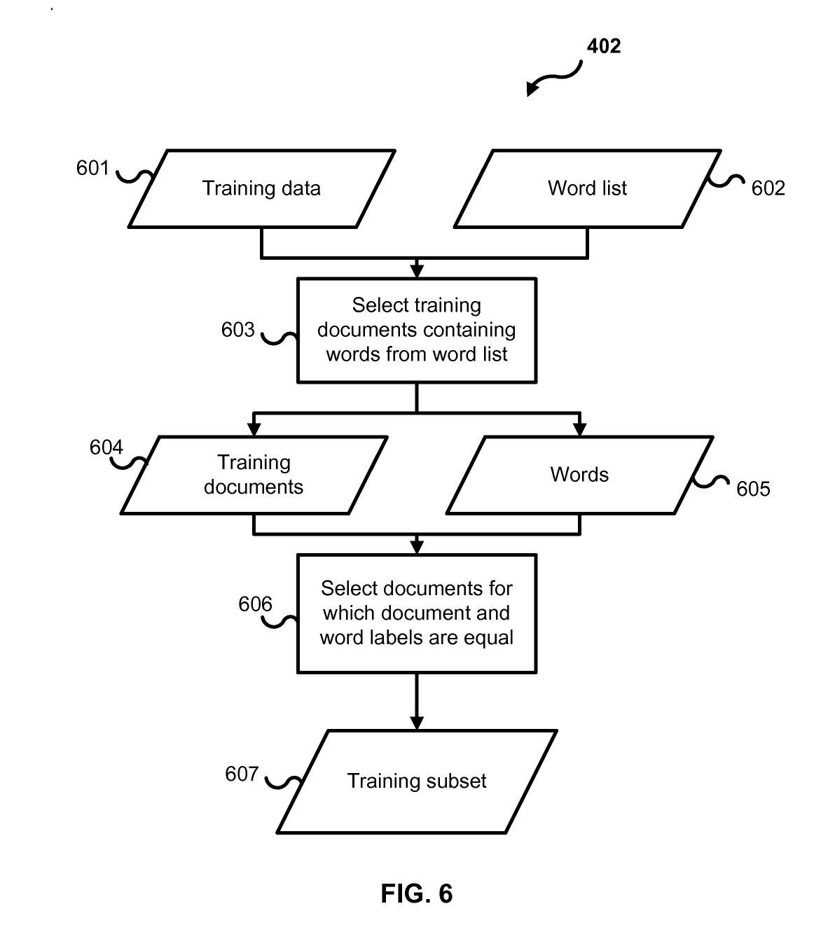

FIG. 6 shows a flow diagram of a process for creating the training subset 402. First, documents in the training set 601 that contain words from the word list 602 are selected (603). Then, from these selected documents 604, containing words from the word list 605, a document is selected (606) if the document's label matches the label of at least one word in the word list 604 contained in this document. All selected documents are added to the training subset 607.

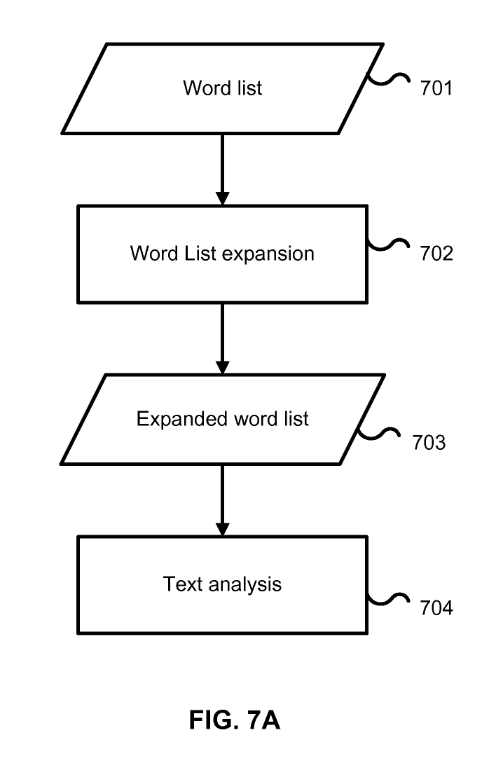

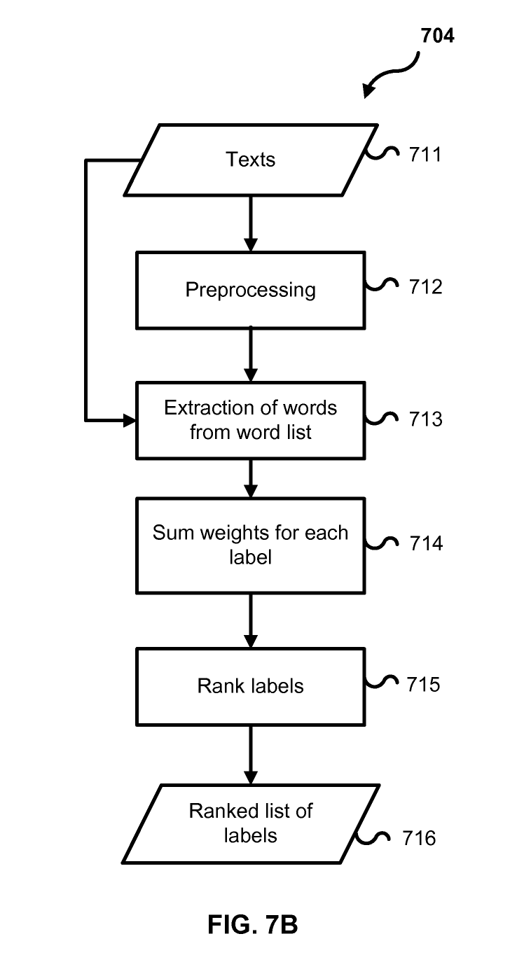

FIG. 7A shows a flow diagram of a process for analyzing text with an expanded word list, according to one embodiment. A word list 701 is expanded 702 using the described method of word list expansion. The expanded word list 703 is then used in text analysis 704. The text analysis 704 may be, for example, a classification—a distribution of texts in accordance to predefined categories or text rankings.

FIG. 7B shows a flow diagram of a process for text analysis 704 using a weighted word list expanded using a method as described herein. In particular, the process ranks possible labels for a given document. Texts 711 may be optionally preprocessed (712), and then the documents 711 are submitted only with words contained in the word list 713. For each label, the weights of all terms with this label are summed up 714. The labels are then ranked (715) according to the value of the sum of the weights. The result is a ranked list of labels 716. Then, a label having the highest ranking may be assigned to a text, or several categories with the highest ranking may be considered.

An illustrative embodiment includes usage of expanded word list for classification of documents in accordance with geographical lexical variation of the language. In other words, the goal of such a classification is to assign a category to a document—geographic region—according to the geographical lexical variation of the language of the author. This problem may be solved with the use of a word list of regional lexicon, manually created, with each word in the word list having one or more geographical labels, according to the region of its distribution (example in FIG. 1). Such word list may be created manually, and may be relatively small in size, and their non-automatic expansion may be time consuming Such word list may be expanded automatically using the training set, in accordance with one embodiment. In the problem of classification of documents according to geographic lexical variation of language, the training set must be marked by geographic regions (a set of labels of the training set contains geographical objects). For example, blogs for which author's hometown is specified in the author's profile, may be used as training set.

With reference to FIGS. 4-5, the disclosed method may include parameter tuning or selection of the parameters. In particular, the threshold value T 414, 514 for the feature selection function Fsf(w, C) 412, 513 may be selected. For example, if the values of the feature selection function Fsf(w,C) 412, 513 are between 0 and 1, the possible threshold values for selection may be following: [0; 0.1; 0.2; 0.3; 0.4; 0.5; 0.6; 0.7; 0.8; 0.9] (where 0 value corresponds to a case in which no threshold is used). Possible threshold values may be tested on labeled training data, and the best value one is then used in the method/algorithm.

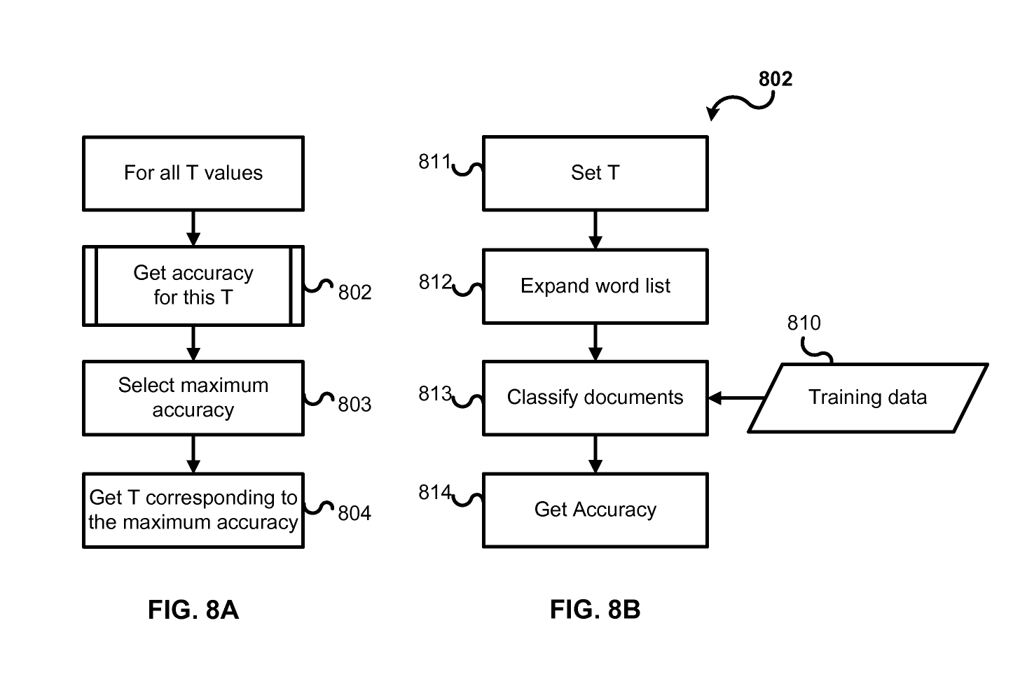

FIG. 8A shows a flow diagram of a threshold selection method according to one or more embodiments. The threshold value is selected in vivo (i.e., its quality is evaluated as a part of a broader problem such as a text analysis task). First, the accuracy of the text analysis is determined using every possible threshold value (T values) 802. Then the maximum accuracy out of all accuracies obtained in 802 is selected (803). And the threshold value corresponding to the maximum accuracy of the method is chosen (804). This threshold value 804 can then be used in the word list expansion method.

FIG. 8B shows a flow diagram of a method for evaluating the performance of a method 802 for a predetermined threshold value. T is assigned a specific value 811. Then, the word list is expanded 812 with this particular threshold value (example shown in FIG. 4 or FIG. 5). Then the documents from training set 810 are classified (e.g., with a method shown in FIG. 7 where the top ranked label is assigned to the document). Then the performance of this method is evaluated 814. For example, the accuracy or performance of the method may be calculated as a percentage of correctly assigned labels; or as a function of precision and recall.

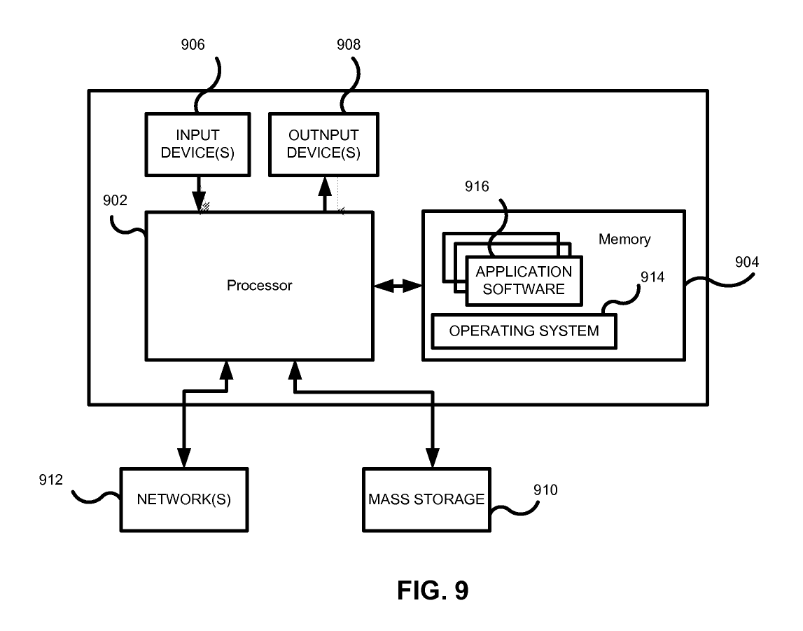

FIG. 9 shows an example of hardware that may be used to implement the system, in accordance with one embodiment of the invention. The hardware typically includes at least one processor 902 coupled to a memory 904. The processor 902 may represent one or more processors (e.g., microprocessors), and the memory 904 may represent random access memory (RAM) devices comprising a main storage of the hardware 900, as well as any supplemental levels of memory, e.g., cache memories, non-volatile or back-up memories (e.g. programmable or flash memories), read-only memories, etc. In addition, the memory 904 may be considered to include memory storage physically located elsewhere in the hardware 900, e.g. any cache memory in the processor 902 as well as any storage capacity used as a virtual memory, e.g., as stored on a mass storage device 910.

The hardware 900 also typically receives a number of inputs and outputs for communicating information externally. For interface with a user or operator, the hardware 900 may include one or more user input devices 906 (e.g., a keyboard, a mouse, imaging device, scanner, etc.) and a one or more output devices 908 (e.g., a Liquid Crystal Display (LCD) panel, a sound playback device (speaker).

For additional storage, the hardware 900 may also include one or more mass storage devices 910, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 900 may include an interface with one or more networks 912 (e.g., a local area network (LAN), a wide area network (WAN), a wireless network, and/or the Internet among others) to permit the communication of information with other computers coupled to the networks. It should be appreciated that the hardware 900 typically includes suitable analog and/or digital interfaces between the processor 902 and each of the components 904, 906, 908, and 912 as is well known in the art.

The hardware 900 operates under the control of an operating system 914, and executes various computer software applications, components, programs, objects, modules, etc. to, implement the techniques described above. Moreover, various applications, components, programs, objects, etc., collectively indicated by reference 916 in FIG. 9, may also execute on one or more processors in another computer coupled to the hardware 900 via a network 912, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method for expanding an electronic word list, the method comprising:
obtaining the electronic word list containing a set of words, wherein each word is associated with a label from a first set of labels;
obtaining a subset of training data containing a set of texts having a second set of labels;
for each word in the electronic word list and a label in the sub-set of the training data, calculating a feature selection criterion;
selecting one or more words for which resulting value of the feature selection criterion calculation is greater than a predetermined threshold value; and
adding the one or more selected words to the electronic word list.

2. The method of claim 1, wherein the second label set includes the first label set.

3. The method of claim 1, further comprising obtaining label mapping information, wherein the first label set is different from the second label set, and the label mapping information indicates a mapping between each label in the first label set and a corresponding label in the second label set.

4. The method of claim 1, wherein the first label set includes labels having numeric values.

5. The method of claim 1, wherein the first label set includes labels having text-based values.

6. The method of claim 1, wherein value of the feature selection criterion is calculated using a chi-square test.

7. The method of claim 1, wherein the step of calculating the feature selection criterion includes obtaining one or more additional feature selection criteria;
calculating value of each criteria;
normalizing the calculated values; and
determining a maximum value from the normalized values.

8. The method of claim 1, wherein a weight is associated with each word in the electronic word list.

9. The method of claim 8, further comprising calculating a weight for each of the selected one or more words that is directly proportional to the value of the feature selection criteria and inversely proportion to a number of iteration.

10. The method of claim 1, wherein the step of obtaining the subset of training data comprises selecting texts from a training set that contain words from the electronic word list, wherein each of the selected text's labels matches a label of at least one word in the electronic word list.

11. The method of claim 1, further comprising analyzing text using the electronic word list having the one or more added words.

12. A system comprising:
one or more data processors; and
one or more storage devices storing instructions that, when executed by the one or more data processors, cause the one or more data processors to perform operations comprising:
obtaining an electronic word list containing a set of words, wherein each word is associated with a label from a first set of labels;
obtaining a subset of training data containing a set of texts having a second set of labels;
for each word in the electronic word list and a label in the sub-set of the training data, calculating a feature selection criterion;
selecting one or more words for which resulting value of the feature selection criterion calculation is greater than a predetermined threshold value; and
adding the one or more selected words to the electronic word list.

13. The system of claim 12, wherein the second label set includes the first label set.

14. The system of claim 12, the operations further comprising obtaining label mapping information, wherein the first label set is different from the second label set, and the label mapping information indicates a mapping between each label in the first label set and a corresponding label in the second label set.

15. The system of claim 12, wherein the first label set includes labels having numeric values.

16. The system of claim 12, wherein the first label set includes labels having text-based values.

17. The system of claim 12, wherein value of the feature selection criterion is calculated using a chi-square test.

18. The system of claim 12, wherein the step of calculating the feature selection criterion includes: obtaining one or more additional feature selection criteria; calculating value of each criteria; normalizing the calculated values; and determining a maximum value from the normalized values.

19. The system of claim 12, wherein a weight is associated with each word in the electronic word list.

20. The system of claim 19, the operations further comprising calculating a weight for each of the selected one or more words that is directly proportional to the value of the feature selection criteria and inversely proportion to a number of iteration.

21. The system of claim 1, wherein the step of obtaining the subset of training data comprises: selecting texts from a training set that contain words from the electronic word list, wherein each of the selected text's label matches a label of at least one word in the electronic word list.

22. The system of claim 1, further comprising analyzing text using the electronic word list having the one or more added words.

23. A computer-readable storage medium having machine instructions stored therein, the instructions being executable by a processor to cause the processor to perform operations comprising
obtaining an electronic word list containing a set of words, wherein each word is associated a label from a first set of labels;
obtaining a subset of training data containing a set of texts having a second set of labels;
for each word in the electronic word list and a label in the sub-set of the training data, calculating a feature selection criterion;
selecting one or more words for which resulting value of the feature selection criterion calculation is greater than a predetermined threshold value; and
adding the one or more selected words to the electronic word list.
